(19) United States
(12) Patent Application Publication
(10) Pub. No.: US 2021/0264502 A1
(43) Pub. Date: Aug. 26, 2021

(54) Electronic Menu, Ordering, and Payment System and Method

(71) Applicants: Samila Mozafarian, Richmond Hill (CA); Amitis Shadbakht, Richmond Hill (CA)

(72) Inventors: Samila Mozafarian, Richmond Hill (CA); Amitis Shadbakht, Richmond Hill (CA)

(21) Appl. No.: 16/798,966

(22) Filed: Feb. 24, 2020

(51) Int. Cl. G06Q 30/06; G06Q 50/12

(52) U.S. Cl. CPC G06Q 30/0635; G06Q 50/12; G06Q 30/0631; G06Q 30/0643

(57) ABSTRACT

An electronic menu, ordering, and payment system and method for improving efficiency of a dining experience for both restaurants and patrons. The system includes a server having a menu stored thereon and a patron electronic device that can communicate with the server. The server includes an order system that causes the restaurant menu to display on the patron electronic device. The order system further provides for receiving a patron order from the patron electronic device at the server and communicates the patron order to a restaurant waiter electronic device. Moreover, the order system can process payment of the patron order and query the status of a patron order. The system includes receiving and storing a patron profile for making seating reservations through an online reservation system. The patron profile is accessible to other users, wherein users can share information through social media platforms or a patron electronic device.

### BACKGROUND OF THE INVENTION

The present invention relates to an electronic menu, ordering, and payment system and method. More specifically, the present invention relates processing of customer food and beverage orders, routing orders to kitchen, bar, and wait staff, and accepting electronic payments. The electronic menu, ordering, and payment system ensures that menu orders are accurately displayed to the patrons, the patrons ordering is electronically communicated to the restaurant, and payment for the restaurant services is transacted.

Transactions between restaurants and patrons by electronic systems, such as communication via the internet, have opened tremendous opportunities in the fields of providing food and drink services. Patrons are often able to place an order, arrange for payment and delivery, often without human intervention by the patron. For example, customers purchase food and drink orders remotely through an online marketplace, wherein the order must be delivered to the patron by a delivery service.

However, many people still enjoy dining out with friends and family. Additionally, online ordering is not available to patrons in many towns and cities. Thus, these known online ordering systems do not address the overall dining experience, the restaurant staff coordination, the restaurant marketing and ratings, and various other concerns that occur while dining out. In these dining situations, communication must occur between the patron, hostess, and waitstaff in order to make reservations, order food, pickup or receive food to go, among many other exchanges and activities that occur throughout a dining experience. Some people may not enjoy the excess communication or simply may not excel at efficient communication.

Some restaurants allow for online ordering while in a remote location. However, online ordering is not available to patrons that are seated at the restaurant. In the vast majority of cases, the online ordering is limited to delivery and pickup. This limited ordering service prevents a restaurant from serving a patron without requiring waiter interaction during the dining experience. During a restaurant seating, the restaurant staff must complete many tasks to achieve a successful service. For example, the hostess must seat tables the waitress must take orders from patrons and coordinate orders with the chefs, provide each dish in an orderly manner, and accept payment from the patrons. Additionally, during each service a variety of unanticipated events arise that further complicate service, such as additional orders, over seating, and the like.

Patrons now demand more convenient food and drink order options that are communicated via an electronic device. Restaurants are in search for a seamless platform that coordinates service with the restaurant staff while tracking each order. Moreover, restaurants are looking to market themselves to the public through highly rated reviews from patrons. In order to address the lack of a universal restaurant electronic menu, ordering, and payment system, there exists a need for a system that integrates the entire restaurant service experience.

In view of the above concerns, it is desirable to provide an embodiment of the universal restaurant electronic menu, ordering, and payment system and method that integrates all aspects of the restaurant service into a single platform. The present restaurant electronic menu, ordering, and payment system eliminates the problems of known online ordering services. The present restaurant electronic menu, ordering, and payment system minimizes timely and unnecessary interaction between the patrons and the restaurant staff. Further, the system can be implemented by a variety of restaurants.

Moreover, in today's modern world there is a need and demand to save consumers and operators time and effort. The present invention attempts to move away from a “one-size fits all” approach that is currently being used in the food, service, and entertainment industry, and introduce a new personalized system to revolutionize and personalize the consumer experience and interaction in retail settings. Retail operators also benefit by providing a low-cost program that transforms and upgrades their entire customer service capabilities, their restaurant organizations, and overall efficiency.

In light of the devices disclosed in the known art, it is submitted that the present invention substantially diverges in design elements and methods from the known art and consequently it is clear that there is a need in the art for an improvement for an electronic menu, ordering, and payment system and method. In this regard the instant invention substantially fulfills these needs.

### SUMMARY OF THE INVENTION

In view of the foregoing disadvantages inherent in the known types of restaurant electronic menu, ordering, and payment systems now present in the known art. The present invention provides a new restaurant electronic menu, ordering, and payment system wherein the same can be utilized for an entire restaurant dining experience.

It is an objective of the present invention to provide an electronic menu, ordering, and payment system that improves restaurants and patrons dining experience.

In one embodiment, the electronic menu, ordering, and payment system comprises a patron electronic device adapted to communicate with a server, the server adapted to store a restaurant menu thereon. The server includes an order system embedded in a non-transitory computer readable medium comprising logic, that when executed, causes the order system to display the restaurant menu on the patron electronic device. The patron electronic device may be a personal electronic device of patron, or an electronic device provided by the restaurant for use by the patron. The order system further provides for receiving a patron order from the patron electronic device at the server, wherein the patron order includes order information. The order system communicates the patron order to a restaurant waiter electronic device which is adapted to receive updates from the server and the patron electronic device. Moreover, the order system is adapted to process payment of the patron order.

In another embodiment, the electronic menu, ordering, and payment system includes a query system for determining the status of a patron order.

In yet another embodiment, the electronic menu, ordering, and payment system includes an online reservation system having a waitlist that the patron may selectively join.

In yet another embodiment, the electronic menu, ordering, and payment system includes a social interaction system that provide social media features.

In yet another embodiment, the electronic menu, ordering, and payment system includes a point award system and a feedback system.

It is another object of the present invention to provide patrons a single system that removes the need to browse through multiple platforms to address some of their needs/tasks ex, reviews, recommendations reservations, order placement, point system.

It is yet another object of the present invention to systematize and automate tasks/commands for owners and patrons that are beyond human capabilities, such as translating menus and making recommendations for patrons based off of a history of meals and personal preferences/requirements.

In yet another embodiment, the electronic menu, ordering, and payment system provides additional interface features, including but not limited to: customizable theme/menu, customizable sections such as “healthier options”, automatically updated menus, clean up options for patrons: to notify that they would like their dishes cleared as their meal is finished. Beneficial for servers as they won't interrupt guests and faster service is delivered, leaving soon option: Patrons can alert retail settings when they are about to leave to allow the establishments to make preparations for reservations and table clean up, collect information such as cooking times they can use this data to indicate approximate cooking times to make it visible for users next to menu items.

It is therefore an object of the present invention to provide a new and improved restaurant electronic menu, ordering, and payment system that has all of the advantages of the known art and none of the disadvantages.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the electronic menu, ordering, and payment system.

FIG. 2 shows a flowchart of an embodiment of the order system of the electronic menu, ordering, and payment system.

FIG. 3 shows a flowchart of one embodiment of a method of making restaurant reservations of the electronic menu, ordering, and payment system.

### DETAILED DESCRIPTION OF THE INVENTION

Reference is made herein to the attached drawings. Like reference numerals are used throughout the drawings to depict like or similar elements of the electronic menu, ordering, and payment system. For the purposes of presenting a brief and clear description of the present invention, the preferred embodiment will be discussed as used for viewing a restaurant menu, placing a food or drink order, and processing payment of a patron seated in the restaurant via an application running on a patron electronic device.

The figures are intended for representative purposes only and should not be considered to be limiting in any respect. Furthermore, the described features, structures, or characteristics may be combined in any suitable manner in one or more embodiments. In the following description, numerous specific details are provided to give a thorough understanding of embodiments.

Reference will now be made in detail to the exemplary embodiment (s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment” does not necessarily refer to the same embodiment.

As used herein, “computer-readable medium” or “memory” excludes any transitory signals, but includes any non-transitory data storage circuitry, e.g., buffers, cache, and queues, within transceivers of transitory signals. As used herein, “logic” refers to (i) logic implemented as computer instructions and/or data within one or more computer processes and/or (ii) logic implemented in electronic circuitry. References to “display” or “display screen” include any electronic device, such as a computer or table having an interactive touchscreen. References to “patron” is understood to be interchangeable with “customer” and is not necessarily limited to the listed description.

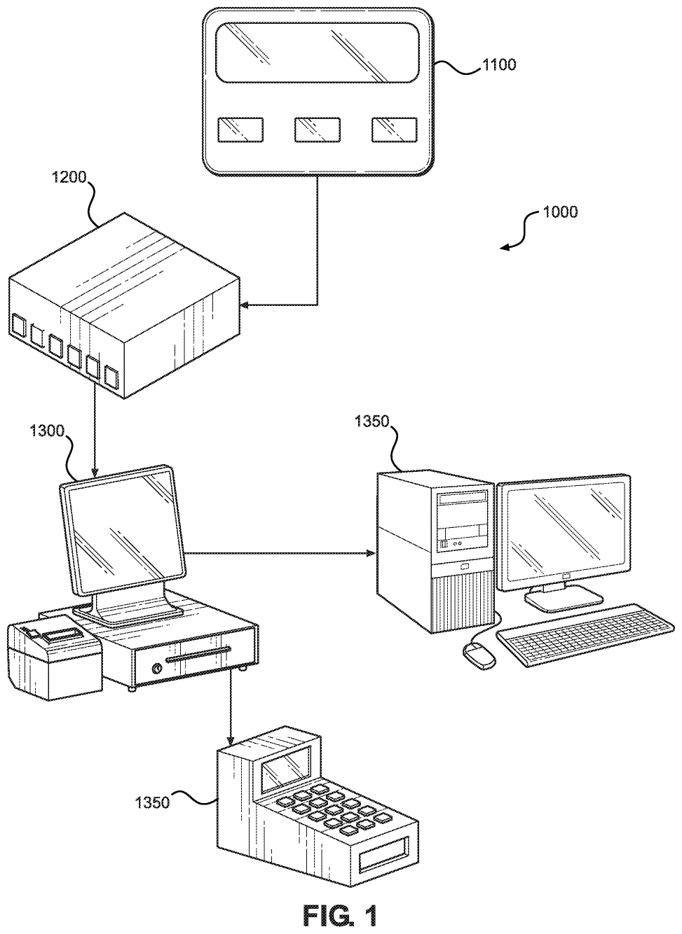

Referring now to FIG. 1, there is shown a perspective view of an embodiment of the electronic menu, ordering, and payment system. The electronic menu, ordering, and payment system 1000 provides restaurants with a system that automates many procedures within the service industry, such as viewing menus, placing food and beverage orders, receiving status updates, processing payment, and the like. Moreover, the restaurant collects vital business information related to patron activities and restaurant staff effectiveness. Further, the electronic menu, ordering, and payment system 1000 provides the patrons the convenience of making reservations, placing food and beverage orders, and making payments without waiting for service or depending upon the responsiveness and staff levels of the restaurant.

The electronic menu, ordering and payment system 1000 comprises a patron electronic device 1100 adapted to communicate with a server 1200, wherein the server 1200 is adapted to store a restaurant menu, among other data, thereon. In one embodiment, the patron electronic device 1100 is a smartphone, tablet, or the like, adapted for wired or wireless communication with the server 1200. In one embodiment, the patron electronic device 1100 is the personal electronic device of each patron. In an alternative embodiment, the patron electronic device 1100 is provided by the restaurant to each patron or group of patrons. In one embodiment, the electronic devices 1100, 1200, 1300 provides finger recognition software or face identification technology for employee sign in, sign out, closings, and other time critical functions.

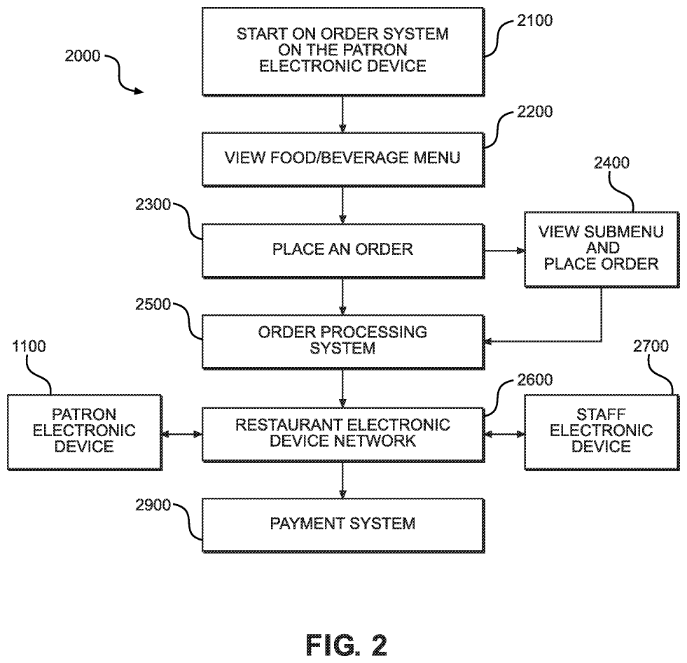

The server, in addition to storing the restaurant menu that is adapted to be selectively updated by the restaurant, includes an order system (one embodiment shown in FIG. 2). The server 1200 is operably connected to an electronic device 1300. The electronic device 1300 may include a network of devices that are distributed among the restaurant staff. In one embodiment, the electronic device 1300 includes network comprising a waiter/waitress device 1350 (hereinafter “waiter” and “waitress” may be used interchangeably), a kitchen device, a front-of house device, and a back of house device. In one embodiment, each device of the electronic devices 1300 provides data needed for the execution of a restaurant service. For example, in one embodiment the waitress device 1350 is a wearable device, such as a wristwatch, that displays patron orders, restaurant messages, and other communications.

In one embodiment, the waitress device 1350 is adapted to send and receive communications to and from the patron. In one exemplary use, the patron may send messages and voice memos from the patron electronic device, such as “add extra sauce” or “drink refill”. Conventionally, patrons would need to wait for the waiter to come to the patron's table to receive the request, and then return to complete the task. Another example includes having a “dropped cutlery”, “table spill”, or “oops” to help normalize the incident to prevent customers from feeling embarrassed. In other embodiments, the present invention provides for additional and customized messages to be transmitted, including but not limited to: “There are kids around us making noise can you please move us to the next convenient table”, “Could you please close the door, there is cold air coming through”, “May you please pull the shades down to prevent the suns light from hitting our table”, and “May you lower/raise the noise of the TV”. By having direct, wireless communication with the patrons, the restaurant staff will not forget any patron requests due to the fact that everything has been electronically recorded. Moreover, restaurants can monitor server behavior. Moreover, in one embodiment, there is an option to send a table a message ex, if the party has stayed there for their maximum time limit, there will be a service charge without an order.

In one embodiment, the electronic menu may be utilized in restaurants. In alternative embodiments, the electronic menu may be utilized in trains, cruise ships, airplanes, lounges, bakeries, catering services, food courts, hotels, grocery stores, diet and fitness programs, and the like.

Referring now to FIG. 2, there is shown a flowchart of an embodiment of the order system of the electronic menu, ordering, and payment system. In one embodiment, the order system 2000 is embedded in a non-transitory computer readable medium comprising logic, that when executed, causes the order system 2000 to run on the patron electronic device.

In one exemplary embodiment, a patron visits the restaurant and utilizes the patron electronic device provided by the restaurant. Upon a prompt by the patron, the system initiates 2100 the order system through a graphical user interface (GUI). The patron may elect to create or otherwise associate with a patron profile or associate as a guest. The patron electronic device displays and accesses the restaurant menu 2200. Prior to accessing the restaurant menu, the restaurant updates the restaurant menu daily with the most recent available food and beverages. The restaurant menu is provided in the GUI that enables the patron to select individual food, drink, and/or another item to form a patron order 2300. In one embodiment, the selection of food or drink will prompt a submenu 2400. The submenu 2400 may include food temperatures, the addition or omission of specific ingredients, portion size, etc.

In one embodiment, the menu may be customizable to hide items or pricing therefrom. For example, a user may select which menu items they want to be included and exclude other items, such as food/drink choices that parties in the group can view/order. This allows a paying user to protect themselves from their guests purposefully ordering expensive foods and drinks.

In one embodiment, a steak is selected from the menu, and a submenu opens to allow the patron to select the desired temperature, which is accompanies by a visual animation and a description. The animation shows how the steak would look like inside and outside, for example showing medium, medium rare. In another embodiment, the restaurant may include menu animations and/or allow for the patrons to customize their patron orders. For example, if one menu item is a chicken wrap that includes a salad, all possible salad combinations can be shown and illustrated in the submenu to allow the customers to choose the animation and picture, thereby personalizing and improving the ordering experience. In one embodiment, patrons may virtually add items to their order and if any items cost extra, ex, guacamole, the present invention indicate as such and display how the order will look like. In another embodiment, one animation can show if the food provider is currently experiencing a high volume of orders. In one embodiment, the animation includes one or more colors to indicate time left till reservations or till when table is ready. For example, a red light indicates two hours left, a blue light indicates one hour left, and a green light indicates thirty minutes left.

In one embodiment, the patron order 2400 includes all items selected by the patron. The patron may be defined as an individual, a group of individuals, or any subdivision of patrons.

In the illustrated embodiment, after selection of the patron order, the patron order is processed 2500 and the patron electronic device communicates the patron order to the electronic device. The electronic device is adapted to receive updates from the server and the patron electronic device. In one embodiment, the electronic device processes the patron order 2600 so as to send critical information to each of the division of the electronic device. In one embodiment, the patron may preorder meals for designated times. This is particularly useful for industries with scheduled activities, such as planes, trains, restaurants, and the like. The food provider may prepare by obtaining the need supplies and give additional option to the patron to upgrade.

In one exemplary use, the electronic device receives the patron order and transmits a food element to the kitchen staff electronic device and the wait staff electronic device 2700, respectively. Each food or drink item is associated with an item price. The item price of the patron order is transmitted to the house restaurant electronic device for processing via the payment system 2900, when an order or the dining experience is complete. Each subdivision of the electronic device network requires the item of the patron order to proceed with the restaurant services. After or during the restaurant service, the patron makes a payment via the payment system 2900. In one embodiment, the payment system 2900 provides for all forms of electronic payment. Additionally, the bill for the patron order may be subdivided among each patron or patron group to allow for divided payment. In one embodiment, the restaurant can allocate a patron tip to certain staff members. For example, the present invention provides for tip distribution to both servers and other workers such as kitchen workers or solely to the waiter/waitress.

In the illustrated embodiment, the patron receives or is adapted to receive updates of service and the patron order via a query system 2850. The query system 2850 transmits a request for information, such as status of the food and drink. In one embodiment, the order system automatically provides status updates. Alternatively, the patron selectively sends status requests. In some embodiments, the GUI of the order system is configured to display a countdown until the order will arrive.

In one embodiment, the query system provides menu item status updates in three stages: “order received”, “order in progress” “order complete”. When the menu item is complete the kitchen staff transmits manually or automatically to the patron the status. The query system prevents food from becoming cold/food will make its way to the patron faster, helps the restaurant keep track of how long it takes for the food to become prepared (collect data), and allows the patron to make quick changes to the patron order if they mistakenly included a menu item or changed their mind before the patron order has begun preparation.

In one embodiment, patrons are able to tap the menu and an accurate description of each menu item is provided, such as a list of ingredients. In another embodiment, a text-to-speech module provides audible descriptions to the patrons. In yet another embodiment, the menu includes hypertext to highlight menu. For example, certain menu items, such as ingredients are viewable in a web browser tab links to definition and pictures of the hypertexted menu item. In another embodiment, the menu will provide a translation of the menu into a different language.

In another embodiment, the menu includes a filter having certain predetermined filtering categorizes, such as low calorie, low cholesterol, price range. This provides the added benefit for those patrons with certain health conditions and or preferences, such as diabetes, vegetarian, certain allergies, and the like.

In one embodiment, the menu provides for certain modifications to be introduced to the patron's tables for special events such as birthdays, anniversaries etc. For example, the present invention allows specific decorations/table pieces to be used at the table, such as a red tablecloth to signify anniversary or have flowers/balloons ordered delivered to table.

In one embodiment, the present invention includes a simplified interface for use by those who may not be able to work with technology as well. (ex, older individuals who may not be able to navigate through apps with ease.) In one embodiment, the retailer may include a map of their establishment on their profile, indicating amenities such as bathrooms.

In one embodiment, the present invention includes unique delivery packaging composed of containers with specially insulated material which will keep food at the desired temperature increasing freshness. Moreover, each container may include a sticker seal on the food to prove food was not tampered with.

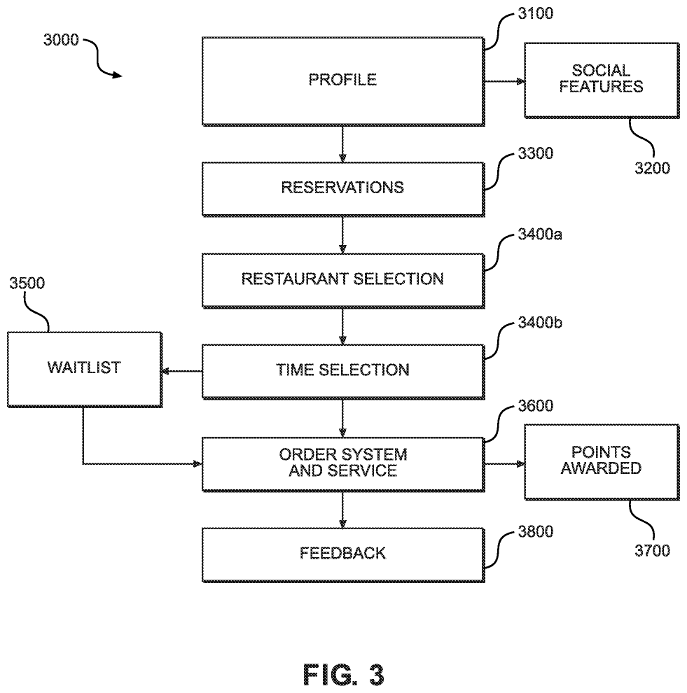

Referring now to FIG. 3, there is shown a flowchart of one embodiment of a method of making restaurant reservations of the electronic menu, ordering, and payment system. The system and method of making restaurant reservations 3000 provides the patrons and the restaurants with a system for scheduling future dining. In one embodiment, the electronic menu, ordering, and payment system includes a plurality of restaurants listed thereon, in a searchable format, via the GUI, for the patron.

In one exemplary use, the reservation system 3000 provides for the formation of patron profiles 3100. The patron profile 3100 may include information related to the patron, such as a history of restaurant attendance, likes and dislikes, and reviews of restaurant. In one embodiment, the present invention analyzes patron profile, restaurants, and the interaction therebetween, to formulate suggestions of restaurants, menu items, and the like. The data analyzed by the system includes but is not limited to restaurant patronage history, order history, food preference, price range data, and the like. In one embodiment, the present invention utilizes artificial intelligence to iteratively improve the suggestions.

In one embodiment, the artificial intelligence may assist with restaurant and food recommendations, directions, the making of reservations, generation of surveys, logging food and drinks into a food journal. The patron electronic device may also access the stored images thereof. In one example, users of the system may track patrons in which they are associated therewith via a connection through the patron profile. The tracking feature allows a user to receive updates, such as but not limited to estimated time of arrival to a dining location, as well as receiving location updates via a map display. In another example, the present invention provides users with a route to the restaurant destination. While in transit, the artificial intelligence may communicate with other associated patrons to provide a location update.

In one embodiment, each patron may name their AI and customize it with a bit emoji concept or through a list of choices. In another embodiment, all user profiles of a group are combined (preferences, budget etc.) and restaurants are recommended that meet the average or preferred criteria of all combined users.

The artificial intelligence also provides the ability to place orders without any physical interaction of the patron and the retailer or service provider. In one exemplary use, a Patron is driving to work and would like to place an order to Retailers on their way. P: “Place an Order for Retailer.” If a preferred location is stored in their profile, the Patron can indicate that to their AI). AI: “Which Retailer, your closest store is 16th and Yonge”. (Then the locations will be listed to the Patron in order of distance, they can either tap on their preferred spot or say it verbally. If the patron has the navigation running to a certain address a patron can filter the locations that are on their way to be displayed only.) AI: “Okay, 16th and Yonge, what would you like to order?” P: “Order me a Big Mac Combo with a coke. AI “The total is $11.34 how would you like to pay.” P: “Pay with Visa 1 “. (On each Patron's profile they can name each of their card payments). AI “Order 45903 has been processed “. For establishments such as Retailer where they have the option to pick up the order at the curbside, the AI will ask them how they will pick it up. AI: “Order 45903 has been processed, pick up in store or curbside”. P: “Curbside”. The information will be sent to the retailer and the given location will be sent to the AI who will read it to the Patron. AI: “Please pick up your order at Curbside 5”.

In one embodiment, customers have developed a routine and purchase specific item selections each visit to a retailer. There will be an option for them to save their specific order and payment method with and distinguish each with a chosen name. Then, they can have their AI order that specifically without having to need to repeat the order each time. The preferred location can also be selected and saved if it is from a multi franchise establishment.

In yet another embodiment, Artificial Intelligence of the system also has the ability to perform tasks for retail setting employers. For example, a server at a restaurant can have the AI assist in the completion of many tasks to ease their role and improve their service.

In one embodiment, each patron creates an individual patron profile with private information, such as interests, health concerns, and allergies. The server stores the patron profile and generates recommendations or restaurant options, menu item options based on provided preferences. For example, a patron may include dining location preferences, food preferences, and budget preferences. Moreover, the system is configured to receive and store ratings from each patron. For example, once a patron orders an item, that item is stored on their patron profile. Once stored, the patron is able to rate the menu item in the profile. The recorded item will also serve to generate similar recommendations and establish customers preferences. In one embodiment, multiple profiles may be created under an account for close family members and friends.

When accessing the patron profile, the patron is connected via social media features 3200 to other patrons and restaurants. An example of these social media features includes, but is not limited to text and video messages, sharing images, commenting on public and private boards, scheduling future events, monitors the location of other patron friends, split bills, and the like. For example, one patron of a group of people may decide to meet at a specific restaurant and through the present invention, the patron can make a reservation at an available time slot and select the associated patrons from the group to be added to the reservation. Here, all patrons can manage the reservations, make changes, and make special requests. Moreover, they can begin to interact with one another and view the restaurant menu, if the restaurant decides to release their menu.

In one embodiment, users can send messages to one another and be able to receive directions as well. All parties that have their location services on will be able to, view the location of the associated patrons and get updates as to when other associated patrons will arrive by locating their whereabouts on a map and estimated time to arrival.

In one embodiment, a patron may view other profiles nearby, send messages, purchase offers to other patrons.

In another embodiment, a QR code with the reservation information will be provided to the party to allow the patron to be seated by the restaurant staff without having to look around for their table. The restaurant staff will scan the QR code and find the other members of the reservation. Whenever a patron arrives, the location or QR code unique to the reservation sends a notification to the restaurant and then they can monitor tables to identify the patrons that have arrived, yet to arrive, and when all patrons have arrived.

In one embodiment, the QR codes provide additional privacy as restaurants may have the option of using QR codes if they do not want patron members to have continuous access to their menu.

In some embodiments, the server provides a list of restaurants that are available for making reservations 3300. Once the restaurant is selected 3400a, the system displays a list of available time and date 3400b options for each restaurant for parties of certain sizes. The reservation system also provides a waitlist 3500 that places patrons in a queue for the restaurant. In one exemplary use, is a patron is running late and patron electronic device is adapted to determine your location and transmit the location information to the server and the restaurant, allowing the restaurant to dynamically change the reservation time by selecting a patron from the waitlist to jump the queue. The waitlisted patron proceeds to the next available table at the restaurant and reserve the table for the late patron arrive based on the time/location of the patron. In one embodiment, the restaurant may choose a time frame to keep or cancel reservation for a certain time periods, such as thirty minutes. Thereby, the restaurant tracks late patrons and cancelations while preventing patrons from losing their reservation time if they are running late. In one embodiment, the restaurant may charge a fee for making the reservation or using the waitlist to cover for the late patron.

In one embodiment, after the patron arrives at the restaurant at the designated reservation time, the restaurant provides service 3600 via the order system of FIG. 2. After service 3600, the patron may be awarded points via a Point Award System 3700. In one embodiment, the Point Award System 3700 includes awarding patron points for behavior conducive to certain behaviors, such as attending reservations, completing surveys, and the like.

In one embodiment, every patron transaction will receive points. The patrons may redeem these points for restaurant gift cards, items (such as wine), electronics etc. The restaurant may also include a charity option where a portion of the transaction will be donated. In one embodiment, a two point awards system allows for points to be awards through use of the present invention and for additional points to be awarded from the food providers.

In one embodiment, all employee and customer interactions will be monitored. In one example, an order is placed by a patron, the item is then sent to the kitchen the system will monitor all processing and pick up times by each staff member and section. For instance, how long, it took the chef to prepare, how long it took the server to pick up the order take it to the table etc. If there are any errors along the way for ex, a server takes longer than usual to pick up the food or makes a mistake this will all be noted in their employee profile which will allow manage to monitor. Also, for instance if a customer makes a complaint such as the food is burnt, this will be noted in the profile that the chef overcooked the product (again recorded in their employee profile). This allows retail operators to monitor staff behavior and customer interactions in a unique way that allows them to make appropriate changes when needed to maximize efficiency and customer satisfaction.

In one embodiment of the present invention, a feedback system 3800 provides for the public or private posting of reviews, comments, likes/dislikes, and electronic surveys. The electronic survey makes data collection faster and more efficient as patrons can rate their overall experience. To motivate patrons to leave surveys, points can be offered.

In one embodiment of the present invention, the review system filters out bias from the Patron to not negatively impact retailers or restaurants. In one example, if a patron does not enjoy sweet foods, and gives the item a bad review based on their preference, the review system can account for this specific patron bias or preference.

In one embodiment, the present invention provides for the monitoring and collecting of data including, which restaurants are busier during certain times of the day, what is being ordered, and patron complaints, suggestions, and requests. In one example, when a patron makes a complaint about their order, the data is shared only between the manager and the patron. This information may be useful to restaurant management to make changes and to monitor irregularities, or patron opinions and habits. In another embodiment, the patron may make a request to delay items or entrees while ordering to enhance the patrons dining experience as they can customize their visit to meet their needs and requirements.

In one embodiment, restaurants may send exclusive or nonexclusive offers to the patron electronic devices for certain menu items. These offers may be limited to certain times or run indefinitely. In one example, restaurant staff may monitor a patron table and its orders so to time the offer at a specific time. For instance, the restaurant staff may notice that a table of patrons have not included in the patron order any appetizers, and the restaurant staff elects to send an exclusive offer to their patron electronic device, such as 30% off one appetizer to motivate further transactions Alternatively, the restaurant staff may elect to add and remove offers to their choosing.

In yet another embodiment, the restaurant may provide special deals for the day or a couple hours to enhance sales. For example, if a restaurant has a certain menu item that is perishable, that menu item may receive a promotion for a 25% discount.

In one embodiment, the present invention provides notifications to patrons with information related to foods and brands to avoid, new illnesses, new innovations, restaurant openings, and the like. Additionally, information such as the health check and certificates are also provided.

In one embodiment, the present invention provides location-based information to the user. In one example, the present invention may provide to the user the current location of the user, guided arrows to stores, and provide directions as well as highlight amenities such as washrooms and allow them to locate food options based on profile preferences.

In one embodiment, the present invention allows restaurants and other providers to describe all facilities and amenities. For example, activities such as playing cards, board games, and the like. Further, parking and valet information may be provided, as well as features to help users locate food providers which are pet friendly, have handicap options, serve alcohol, have TV (for sports users), child friendly, playground/play place for kids, dietary options such as Halal meat, allergy options, vegetarians friendly, and the like.

In one embodiment, the present invention provides a bidding system that allows patrons to post information related to a future event and have food providers place bids to host the event. This information will be stored to the system and will be sent to applicable food providers/restaurants/caterers which will then begin to bid against one another and give the customer the ability to choose from the offers.

In one embodiment, the present invention provides for party planning by providing users categories, such as food, beverage, and the like, wherein menus from food providers are recommended for each category. Further, user profile and preference can guide the recommendations. Once all selected, the entire order is processed and fulfilled by the individual providers.

In one embodiment, the present invention provides notifications to a patron when that patron is repeated customer at a retailer or restaurant, so that the retailer or restaurant can send them exclusive offers or appreciation items.

In one embodiment, the present invention provides reports and allow retail settings access to see what their competitors are offering consumers and allow them to adjustments, price match, and the like. In another embodiment, a retailer may implement a unique prize system which allows them to reward customers and increase sales. For example, when a customer is finished with the meal an option will occur for them to for example encourage dessert sales. A retailer can set the table a unique offer or they can have option to spin the wheel for a deal and they can make a mandatory setting where if consumers decide to spin the wheel, they must make a purchase. Once they spin the wheel, they are presented with offers such as 15 percent off, free tea with cake etc. (they can also implement the prize meals to consumers of their liking ex, offer it to consumers who spent over $150 dollars on their bill, unhappy customers).

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An electronic menu, ordering and payment system, comprising:
a patron electronic device adapted to communicate with a server, the server adapted to store a restaurant menu thereon;
the server having an order system embedded in a non-transitory computer readable medium comprising logic, that when executed, causes the order system to:
display the restaurant menu on the patron electronic device;
receive a patron order from the patron electronic device at the server, wherein the patron order includes order information;
communicate the patron order to a restaurant waiter electronic device, the electronic device adapted to receive updates from the server and the patron electro sic device;
process payment of the patron order.

2. The electronic menu, ordering and payment system of claim 1, wherein a patron profile is stored on the server, wherein the patron profile is unique to each patron and adapted to store past order information.

3. The electronic menu, ordering and payment system of claim 2, wherein the server is configured to suggest additional items to add to the patron order based on either the patron profile or other patron orders from other patrons.

4. The electronic menu, ordering and payment system of claim 1, wherein the service is configured to alloy the restaurant to update the restaurant menu at any given time and for patrons to view and order therefrom.

5. The electronic menu, ordering and payment system of claim 1, wherein the server stores a reservation system embedded in the non-transitory computer readable medium comprising logic, that when executed, causes the reservation system to:
display a reservation time on the patron electronic device and allow selection thereof.

6. The electronic menu, ordering and payment system of claim 5, wherein the reservation system further comprises:
creating a waitlist queue for patrons and communicate a status of the waitlist queue to the patron electronic device.

7. The electronic menu, ordering and payment system of claim 5, wherein the reservation system includes a plurality of restaurant each having a distinct

8. The electronic menu, ordering and payment system of claim 1, wherein the server stores a feedback system embedded in the non-transitory computer readable medium comprising logic, that when executed, causes the feedback system to:
allow the patron electronic device to comments rating, and post reviews of the restaurants onto the server;
provide for social network communication between patron electronic devices.

9. The electronic menu, ordering and payment system of claim 1, wherein the server collects patron data associated with a patron profile, where the patron data includes order history, time between order and service, and restaurant reservations.

10. The electronic menu, ordering and payment system of claim 1, wherein the patron electronic device is adapted to query the server to predicts a time until delivery of the patron order to the patron.

11. The electronic menu, ordering and payment system of claim 1, wherein the patron electronic device is adapted to transmit an acceptance request to the restaurant to determine if the patron order has been accepted, wherein the restaurant is adapted to respond to the acceptance request that the request has been accepted.

12. The electronic menu, ordering and payment system of claim 1, wherein the electronic device includes a network comprising a waiter device, a kitchen device, a front-of house device, and a back of house device.

13. The electronic menu, ordering and payment system of claim 12, wherein the patron electronic device, the waiter device, are located within the restaurant.

14. The electronic menu, ordering and payment system of claim 1, wherein the restaurant menu is provided in a GUI that enables the patron to select individual food or drink items to form the patron order.
